(19) United States
(12) Patent Application Publication
(10) Pub. No.: US 2023/0384193 A1
(43) Pub. Date: Nov. 30, 2023

(54) TIME-DEPENDENT LOCAL STRESS-STRAIN METHOD AND TOOL SOFTWARE FOR HIGH-TEMPERATURE STRUCTURAL STRENGTH AND SERVICE LIFE ANALYSIS

(71) Applicant: EAST CHINA UNIVERSITY OF SCIENCE AND TECHNOLOGY, Shanghai (CN)

(72) Inventors: Fuzhen XUAN, Shanghai (CN); Cheng GONG, Shanghai (CN); Jianguo GONG, Shanghai (CN)

(21) Appl. No.: 18/031,318

(22) PCT Filed: Oct. 13, 2020
(86) PCT No.: PCT/CN2020/120563

§ 371 Date: Apr. 11, 2023

(51) Int. Cl. G01N 3/06

(52) U.S. Cl. CPC G01N 3/066

(57) ABSTRACT

The application discloses a time-dependent local stress-strain method for high-temperature structural strength and service life analysis. The method is aimed at a load component under high-temperature conditions, and the load component has a structural discontinuity area. The method includes: a step for obtaining working conditions, a step for obtaining material parameters, an elastoplasticity analysis step, a limit analysis step, an elasticity analysis step, a boundary condition setting step, an iterative operation step, and a result integration step. The application also discloses time-dependent local stress-strain tool software for high-temperature structural strength and service life analysis. The tool software includes: a parameter acquisition assembly, a finite element modeling and operation assembly, an iterative operation assembly, and a result display assembly.

### TECHNICAL FIELD

The present application relates to the field of computer simulation technology, and more particularly to computer simulation technology for high-temperature structural strength and service life analysis.

### BACKGROUND

With the urgent needs of national energy conservation and consumption reduction and environmental protection, the development of a new generation of advanced ultra-supercritical steam turbine unit technology has become an important topic faced by domestic thermal power, nuclear power, and other industries. In advanced energy equipment, a large number of engineering components are facing extreme operating conditions such as high temperature and high pressure. For example, the normal operating temperature of the intermediate heat exchanger support in the fast reactor nuclear power system is 540° C., and its temperature under transient conditions can reach 610° C., which both exceed the creep initiation temperature of the corresponding material that is 316H stainless steel. Therefore, the problems of creep deformation and fracture are the failure modes that need to be focused on in the strength design and safety evaluation of nuclear power high-temperature structures.

As for homogeneous members subjected to uniaxial load, the stress-strain response of the structure under creep behavior can be calculated based on the creep constitutive equation after the initial stress and strain are determined. However, there are usually a lot of structural discontinuity areas such as openings, chamfers, etc. in the geometric structure of actual components, and there are significant stress and strain concentrations in the areas. Accurate calculation of creep stress-strain behavior of critical points in the area is an important link in structural integrity evaluation. The existing time-independent local stress-strain methods (such as Neuber method) cannot describe the time-dependent creep behavior of high-temperature structures. Part of researchers may lead to errors when the Neuber equation is generalized to the stress-strain response prediction for high-temperature structures. How to construct a more accurate stress-strain method, that is, a time-dependent local stress-strain method, is an important topic in the field of structural integrity.

In summary, the existing prediction methods for creep stress-strain behavior at critical points in stress concentration areas in elastic analysis do not take the effects of structures and load types into account, resulting in excessively conservative or non-conservative analysis results. Therefore, it is urgent to propose an improved time-dependent local stress-strain method to realize accurate prediction at critical points in stress concentration areas.

### SUMMARY OF THE APPLICATION

According to an embodiment of the present application, the present application proposes a time-dependent local stress-strain method for high-temperature structural strength and service life analysis. The method is aimed at a load component under high-temperature conditions, and the load component has a structural discontinuity area. The method comprises:
a step for obtaining working conditions, wherein the working conditions comprise a design temperature, a design load, total load holding time, material, and a structural critical point of component related to the structural discontinuity area;
a step for obtaining material parameters, wherein the material parameters comprise the creep constitutive equation, elastic modulus, Poisson's ratio, stress-strain curve, and equivalent elastic modulus of the material, and a finite element model is established according to the material parameters and working conditions;
an elastoplasticity analysis step, which is to perform an elastoplasticity analysis based on the finite element model to determine the initial equivalent stress, initial equivalent strain of the structural critical point of component and initial stress in the far field area;
a limit analysis step, which is to perform a limit analysis based on the finite element model to determine the ultimate load and the initial reference stress of the structural critical point;
an elasticity analysis step, which is to perform an elasticity analysis based on the finite element model to determine the elastic stress, elastic strain, and stress concentration factor of the structural critical point;
a boundary condition setting step, which is to set the boundary conditions for the iterative operation, wherein the boundary conditions comprise: total load holding time, total time, maximum allowable stress drop, and time step;
an iterative operation step, which comprises:
in each iteration step, calculating displacement control intermediate variables and load control intermediate variables, and calculating the resulting variable of each iteration step based on the displacement control intermediate variables and the load control intermediate variables, wherein the resulting variable is stress drop;
comparing the stress drop with the maximum allowable stress drop; if the stress drop is greater than the maximum allowable stress drop, adjusting the time step and subsequently recalculating intermediate variables and resulting variable of the iteration step;
if the stress drop is not greater than the maximum allowable stress drop, outputting the calculation results of the iteration step: total stress, total strain, reference stress, reference strain, far field stress, and total load holding time;
judging whether the calculation time has reached the total time; if the total time has been reached, ending the iterative operation step;
if the total time is not reached, proceeding to the next iteration step;
a result integration step, which is to determine the correlation between local stress and strain of structural critical point of component and time according to the calculation results output by all iteration steps.

In one embodiment, in the step for obtaining material parameter,
the material parameters are obtained by querying a material performance library, which comprises:
in the material performance library, obtaining the elastic modulus E, Poisson's ratio v, and creep constitutive equation \dot{ε}_{c}=Aσⁿ of the material at a design temperature T, wherein \dot{ε}_{c}is the creep strain rate, σ is the stress, A is the creep constitutive parameter, and n is the stress index parameter in the creep constitutive equation, and calculating the equivalent elastic modulus Ē:

$$\overline{E} = \frac{3 E}{2 ( 1 + v )} ;$$

obtaining a stress-strain curve of the material at a design temperature T in the material performance library;
or, the material parameters are obtained by testing, which comprises:
testing the material by using a static method or a dynamic thermomechanical analyzer to obtain the elastic modulus E and Poisson's ratio v at a design temperature T,
performing a tensile creep test with round bar on the material at the design temperature T to obtain a creep constitutive equation \dot{ε}_{c}=Aσⁿ, wherein \dot{ε}_{c}is the creep strain rate, σ is the stress, A is the creep constitutive parameter, and n is the stress index parameter in the creep constitutive equation,
calculating the equivalent elastic modulus Ē:

$$\overline{E} = \frac{3 E}{2 ( 1 + v )} ;$$

performing a tensile test with round bar on the material at the design temperature T to obtain the plastic extension strength of the material, and obtaining the stress-strain curve of the material based on the plastic extension strength.

In one embodiment, in the limit analysis step, a limit analysis is performed based on a finite element model to obtain the ultimate load P_{L}, and the initial reference stress σ_{ref}⁰ of the structural critical point is calculated according to the ultimate load:

$${σ}_{ref}^{0} = \frac{P}{{P}_{L}} {σ}_{y} ;$$

wherein, P is the design load, p_{L} is the ultimate load, and σ_{y} is the yield strength.

In one embodiment, in the elastic analysis step, the elastic stress σ_{elastic} and elastic strain ε_{elastic} of the structural critical point are determined through elastic analysis based on the finite element model, and then the stress concentration factor Kₜ at the structural critical point is calculated:

$${K}_{t} = \sqrt{\frac{{σ}_{elasstic} {ε}_{elastic} E}{{σ}_{ref}^{2}}} ;$$

wherein, E is the elastic modulus, σ_{ref} is the initial reference stress at the structural critical point.

In one embodiment, in the iterative operation step, the displacement control intermediate variables comprise: creep strain increment, far field creep strain increment, reference stress drop, far field elastic strain increment, and reference strain increment;
when the component is controlled by displacement, as for each iteration step i, the creep strain increment Δε_{c}ⁱ and far field creep strain increment (Δσᵤₙᵢ^{c})ⁱ corresponding to the iteration step i is calculated according to the creep constitutive equation \dot{ε}_{c}=A\dot{σ}_{c}ⁿ;
and the reference stress drop Δσ_{ref}ⁱ corresponding to iteration step i is calculated:

Δσ_{ref}ⁱ=A(σ_{ref}ⁱ⁻¹)ⁿΔtE;
wherein, A is the creep constitutive parameter, E is the elastic modulus, and Δt is the time step;
the far field elastic strain increment (Δεᵤₙᵢ^{c})ⁱ corresponding to iteration step i is:

$${( {Δε}^{2} \text{?} )}^{i} = - A ( {σ}_{ref}^{i - 1} ) \text{?} Δ t \cdot \frac{{σ}_{uni}^{0}}{{σ}_{ref}^{0}} ;$$

$$\text{?} \text{indicates text missing or illegible when filed}$$

wherein, Δt is the time step and σᵤₙᵢ⁰ is the initial stress;
and the reference strain increment Δε_{ref}ⁱ corresponding to iteration step i is:

Δε_{ref}ⁱ=(Δεᵤₙᵢ⁰)ⁱ+(Δεᵤₙᵢ⁰)ⁱ.

In one embodiment, in the iterative operation step, the load control intermediate variables comprise: creep strain increment and reference strain increment;
when the component is controlled by load, as for each iteration step i, the far field creep strain increment is (Δεᵤₙᵢ⁰)ⁱ=0, far field elastic strain increment is (Δεᵤₙᵢ^{c})ⁱ=0, reference stress drop is Δσ_{ref}ⁱ=0, and reference creep increment Δε_{ref}^{u} is calculated as follows:

Δε_{ref}ⁱ=A(σ_{ref}ⁱ⁻¹)Δt;
wherein, A is the creep constitutive parameter, and Δt is the time step.

In one embodiment, in the iterative operation step, as for each iterative step i, the resulting variable namely the stress drop Δσⁱ is calculated as follows:

$$Δσ \text{?} = \frac{K \text{?} ( {Δσ}_{ref}^{i} ( {ε}_{ref}^{i - 1} + {Δε}_{ref}^{i} ) + ( {Δσ}_{ref}^{i} + {σ}_{ref}^{i - 1} ) {Δε}_{ref}^{i} ) - σ \text{?} Δε \text{?}}{{ε}^{i - 1} + \frac{{σ}^{i - 1}}{E} + Δ c \text{?}} ;$$

$$\text{?} \text{indicates text missing or illegible when filed}$$

wherein, K is the stress concentration factor, εc is the creep strain, ε is the equivalent strain, and σ is the stress.

In one embodiment, in the iterative operation step, as for each iterative step i, if the stress drop Δσⁱ is not greater than the maximum allowable stress drop σ_{allow}, the calculation results of this iteration step are output: total stress σⁱ, total strain εⁱ, reference stress σ_{ref}ⁱ, reference strain ε_{ref}ⁱ, far field stress σᵤₙᵢⁱ, and total load holding time tⁱ.
the total stress σⁱ is calculated as follows:

σⁱ=σⁱ⁻¹+Δσⁱ;
the total strain εⁱ is calculated as follows:

εⁱ=εⁱ⁻¹+Δσⁱ/Ē;
wherein, Ē is the equivalent elastic modulus;

the reference stress σ_{ref}ⁱ is calculated as follows:

σ_{ref}ⁱ=σ_{ref}ⁱ⁻¹+σ_{ref}ⁱ;

the reference strain ε_{ref}ⁱ is calculated as follows:

ε_{ref}ⁱ=ε_{ref}ⁱ⁻¹ε_{ref}ⁱ;

the far field stress σᵤₙᵢⁱ is calculated as follows:

$${σ}_{uni}^{i} = {σ}_{uni}^{i - 1} - EA ( {σ}_{ref}^{i - 1} ) \text{?} Δ t \cdot \frac{{σ}_{uni}^{0}}{{σ}_{ref}^{0}} ;$$

$$\text{?} \text{indicates text missing or illegible when filed}$$

the total load holding time tⁱ is calculated as follows:

Tⁱ=tⁱ⁻¹+Δt.

In one embodiment, the structural critical point is selected from the structural discontinuity area based on the stress field.

According to an embodiment of the present application, the present application proposes time-dependent local stress-strain tool software for high-temperature structural strength and service life analysis. The tool software is based on finite element software. The tool software is aimed at a load component under high-temperature conditions, and the load component has a structural discontinuity area. The tool software comprises: a parameter acquisition assembly, a finite element modeling and calculation assembly, an iterative operation assembly, and a result display assembly.

The parameter acquisition assembly obtains working conditions and material parameters, wherein the working conditions comprise a design temperature, a design load, total load holding time, material of component, and a structural critical point of component related to the structural discontinuity area, wherein the material parameters comprise the creep constitutive equation, elastic modulus, Poisson's ratio, stress-strain curve, and an equivalent elastic modulus of the material.

The finite element modeling and calculation assembly establishes a finite element model based on the material parameters; performs an elastoplasticity analysis based on the finite element model to determine the initial equivalent stress, initial equivalent strain of the structural critical point of component, and initial stress in the far field area; performs a limit analysis based on the finite element model to determine the ultimate load and the initial reference stress of the structural critical point; and performs an elasticity analysis based on the finite element model to determine the elastic stress, elastic strain, and stress concentration factor of the structural critical point.

The iterative operation assembly sets the boundary conditions for the iterative operation, wherein the boundary conditions comprise: total load holding time, total time, maximum allowable stress drop, and time step. The iterative operation component performs an iterative operation step, wherein in each iteration step, calculates displacement control intermediate variables and load control intermediate variables, and calculates the resulting variable of each iteration step based on the displacement control intermediate variables and load control intermediate variables, wherein the resulting variable is stress drop; compares the stress drop with the maximum allowable stress drop; if the stress drop is greater than the maximum allowable stress drop, adjusts the time step and subsequently recalculates intermediate variables and resulting variable of the iteration step; if the stress drop is not greater than the maximum allowable stress drop, outputs the calculation results of the iteration step: total stress, total strain, reference stress, reference strain, far field stress, and total load holding time; judges whether the calculation time has reached the total time; if the total time is reached, ends the iterative operation step; if the total time is not reached, proceeds to the next iteration step.

The result display assembly generates a dual axis chart of strain/stress-time according to the calculation results output by all iteration steps, and shows the correlation between local stress and strain of the structural critical point of component and time.

In view of the problem of predicting the stress and strain in local areas of component, the time-dependent local stress-strain method and tool software for high-temperature structural strength and service life analysis proposed in the present application modify the traditional differential Neuber formula based on the stress and strain distribution characteristics of the component, and propose an improved local stress and strain calculation method. In summary, this method and tool software simultaneously solve the problem of predicting stress and strain in local areas of component under load control or displacement control.

### BRIEF DESCRIPTION OF THE DRAWINGS

FIG. 1 illustrates a flowchart of a time-dependent local stress-strain method for high-temperature structural strength and service life analysis according to an embodiment of the present application.

FIG. 2 illustrates the shape of a load component in a specific example of a time-dependent local stress-strain method for high-temperature structural strength and service life analysis according to an embodiment of the present application, wherein the load component is a simplified bolt component.

FIG. 3 illustrates the creep stress-strain behavior at structural critical point of the simplified bolt component shown in FIG. 2.

FIG. 4 illustrates a structural block diagram of time-dependent local stress-strain tool software for high-temperature structural strength and life analysis according to an embodiment of the present application.

### DESCRIPTION OF THE EMBODIMENT

In view of the defect that the prediction method for creep stress-strain behavior at critical points in the stress concentration area in the elastic analysis of the prior art does not take into account the impacts of structure and load types, the present application proposes a time-dependent local stress-strain method for strength and life analysis of high-temperature structures. The method is aimed at a load component under high-temperature conditions, and the load component has a structural discontinuity area. The method comprises:
S1, a step for obtaining working conditions. The working conditions comprise a design temperature, a design load, total load holding time, material of component, and a structural critical point of component related to the structural discontinuity area. In one embodiment, the structural critical point is selected from the structural discontinuity area according to the stress field.
S2, a step for obtaining material parameters. The material parameters comprise the creep constitutive equation, elastic modulus, Poisson's ratio, stress-strain curve, and equivalent elastic modulus of the material. A finite element model is established according to the material parameters and working conditions. There are two ways to obtain material parameters: by querying a material performance library or by testing. In one embodiment, in the step for obtaining material parameters, the material parameters are obtained by querying the material performance library, which comprises:
in the material performance library, obtaining the elastic modulus E, Poisson's ratio v, and creep constitutive equation \dot{ε}_{c}=Aσⁿ of the material at a design temperature T, wherein \dot{ε}_{c} is the creep strain rate, σ is the stress, A is the creep constitutive parameter, and n is the stress index parameter in the creep constitutive equation, and calculating the equivalent elastic modulus Ē:

$$\overline{E} = \frac{3 E}{2 ( 1 + v )} ;$$

obtaining a stress-strain curve of the material at the design temperature T in the material performance library.

Alternatively, in another embodiment, the material parameters can be obtained by testing, which comprises:

Testing the material by using a static method or a dynamic thermomechanical analyzer to obtain the elastic modulus E and Poisson's ratio v at the design temperature T, wherein both static method test and dynamic thermomechanical analyzer test can be used to obtain the elastic modulus E and Poisson's ratio v,
performing a tensile creep test with round bar on the material at the design temperature T to obtain a creep constitutive equation \dot{ε}_{c}=Aσⁿ, wherein \dot{ε}_{c} is the creep strain rate, σ is the stress, A is the creep constitutive parameter, and n is the stress index parameter in the creep constitutive equation,
calculating the equivalent elastic modulus Ē:

$$\overline{E} = \frac{3 E}{2 ( 1 + v )} ;$$

performing a tensile test with round bar on the material at the design temperature T to obtain the plastic extension strength of the material, and obtaining the stress-strain curve of the material based on the plastic extension strength.

In step S2, a finite element model will be established according to material parameters and working conditions. In one embodiment, engineering simulation finite element software may be used when establishing the finite element model. For example, it can be finite element software mainly used for structural mechanics analysis, such as Abaqus, Ansys, etc.
S3, an elastoplasticity analysis step, namely, performing an elastoplasticity analysis based on the finite element model to determine the initial equivalent stress and initial equivalent strain of the structural critical point of the component, and initial stress in the far field area.
S4, a limit analysis step, namely, performing a limit analysis based on the finite element model to determine the ultimate load and the initial reference stress of the structural critical point. In one embodiment, in the limit analysis step, a limit analysis is performed based on the finite element model to obtain the ultimate load P_{L}, and the initial reference stress σ_{ref}⁰ of the structural critical point is calculated according to the ultimate load:

$${σ}_{ref}^{0} = \frac{P}{{P}_{L}} {σ}_{y} ;$$

wherein, P is the design load, P_{L} is the ultimate load, and σ_{y} is the yield strength (i.e. the stress corresponding to 0.2% plastic deformation).
S5, an elasticity analysis step, namely, performing an elasticity analysis based on the finite element model to determine the elastic stress, elastic strain, and stress concentration factor of the structural critical point. In one embodiment, in the elastic analysis step, the elastic stress σ_{elastic} and elastic strain ε_{elastic} of the structural critical point are determined through elastic analysis based on the finite element model, and then the stress concentration factor Kₜ at the structural critical point is calculated:

$${K}_{t} = \sqrt{\frac{{σ}_{elasstic} {ε}_{elastic} E}{{σ}_{ref}^{2}}} ;$$

wherein, E is the elastic modulus, σ_{ref} is the initial reference stress of the structural critical point.
S6, a boundary condition setting step, namely, setting the boundary conditions for the iterative operation, wherein the boundary conditions comprise: the total load holding time, total time, maximum allowable stress drop, and time step.
S7, an iterative operation step, which comprises:
in each iteration step, calculating displacement control intermediate variables and load control intermediate variables, and calculating the resulting variable of each iteration step based on the displacement control intermediate variables and the load control intermediate variables, wherein the resulting variable is stress drop.
comparing the stress drop with the maximum allowable stress drop; if the stress drop is greater than the maximum allowable stress drop, adjusting the time step and subsequently recalculating intermediate variables and resulting variable of the iteration step.

If the stress drop is not greater than the maximum allowable stress drop, outputting the calculation results of the iteration step: total stress, total strain, reference stress, reference strain, far field stress, and total load holding time;
judging whether the calculation time has reached the total time; if the total time has been reached, ending the iterative operation step;

If the total time is not reached, proceeding to the next iteration step.

In one embodiment, in the iterative operation step S7, the displacement control intermediate variables comprise: creep strain increment, far field creep strain increment, reference stress drop, far field elastic strain increment, and reference strain increment;
when the component is controlled by displacement, as for each iteration step i, the creep strain increment Δε_{c}ⁱ and far field creep strain increment (Δεᵤₙᵢ^{c})ⁱ corresponding to the iteration step i are calculated according to the creep constitutive equation \dot{ε}_{c}=Aσⁿ;
and the reference stress drop Δσ_{ref}ⁱ corresponding to the iteration step i is calculated:

Δσ_{ref}ⁱ=A(σ_{ref}ⁱ⁻¹)ⁿΔtE;
wherein, A is the creep constitutive parameter, E is the elastic modulus, and Δt is the time step;

the far field elastic strain increment (Δεᵤₙᵢ^{ε})ⁱ corresponding to iteration step i is:

$${( {Δε}^{2} \text{?} )}^{i} = - A ( {σ}_{ref}^{i - 1} ) \text{?} Δ t \cdot \frac{{σ}_{uni}^{0}}{{σ}_{ref}^{0}} ;$$

$$\text{?} \text{indicates text missing or illegible when filed}$$

wherein, Δt is the time step and σᵤₙᵢ⁰ is the initial stress;
and the reference strain increment Δε_{ref}ⁱ corresponding to iteration step i is:

Δε_{ref}ⁱ=(Δεᵤₙᵢ⁰)ⁱ+(Δεᵤₙᵢ^{c})ⁱ.

In one embodiment, in the iterative operation step S7, the load control intermediate variables comprise: creep strain increment and reference strain increment;

when the component is controlled by load, as for each iteration step i, the far field creep strain increment (Δεᵤₙᵢ⁰)=0, far field elastic strain increment (Δεᵤₙᵢ^{ε})ⁱ=0, reference stress drop Δσ_{ref}ⁱ=0, and reference creep increment Δε_{ref}ⁱ is calculated as follows:

Δε_{ref}ⁱ=A(σ_{ref}ⁱ⁻¹)Δt;
wherein, A is the creep constitutive parameter, and Δt is the time step.

In one embodiment, in the iterative operation step S7, as for each iterative step i, the resulting variable namely the stress drop Δσⁱ is calculated as follows:

$$\text{?} = \frac{{K}_{t}^{2} ( Δ {σ}_{ref}^{i} ( {ε}_{ref}^{i - 1} + Δ {ε}_{ref}^{i} ) + ( Δ {σ}_{ref}^{i} + {σ}_{ref}^{i - 1} ) \text{?} ) - \text{?}}{{ε}^{i - 1} + \frac{{σ}^{i - 1}}{\overline{E}} + Δ \text{?}} ;$$

$$\text{?} \text{indicates text missing or illegible when filed}$$

wherein, K is the stress concentration factor, εc is the creep strain, ε is the equivalent strain, and σ is the stress.

In one embodiment, in the iterative operation step S7, as for each iterative step i, if the stress drop Δσⁱ is not greater than the maximum allowable stress drop σ_{allow}, the calculation results of this iteration step are output: total stress σⁱ, total strain εⁱ, reference stress σ_{ref}ⁱ, reference strain ε_{ref}ⁱ, far field stress σᵤₙᵢⁱ, and total load holding time tⁱ,
the total stress σⁱ is calculated as follows:

σⁱ=σⁱ⁻+Δσⁱ;
the total strain εⁱ is calculated as follows:

εⁱ=εⁱ⁻+Δε₀ⁱ+Δσⁱ/Ē;
wherein, Ē is the equivalent elastic modulus;
the reference stress σ_{ref}ⁱ is calculated as follows:

σ_{ref}ⁱ=σ_{ref}ⁱ⁻+Δσ_{ref}ⁱ;
the reference strain ε_{ref}ⁱ is calculated as follows:

ε_{ref}ⁱ=ε_{ref}ⁱ⁻+Δε_{ref}ⁱ;
the far field stress σᵤₙᵢⁱ is calculated as follows:

$${σ}_{uni}^{i} = {σ}_{uni}^{i - 1} - {EA ( {σ}_{ref}^{i - 1} )}^{n} Δ t \cdot \frac{{σ}_{uni}^{0}}{{σ}_{ref}^{0}} ;$$

the total load holding time tⁱ is calculated as follows:

Tⁱ=tⁱ+Δt.
S8, a result integration step, namely, determining the correlation between local stress and strain of the structural critical point of the component and time according to the calculation results output by all iteration steps.

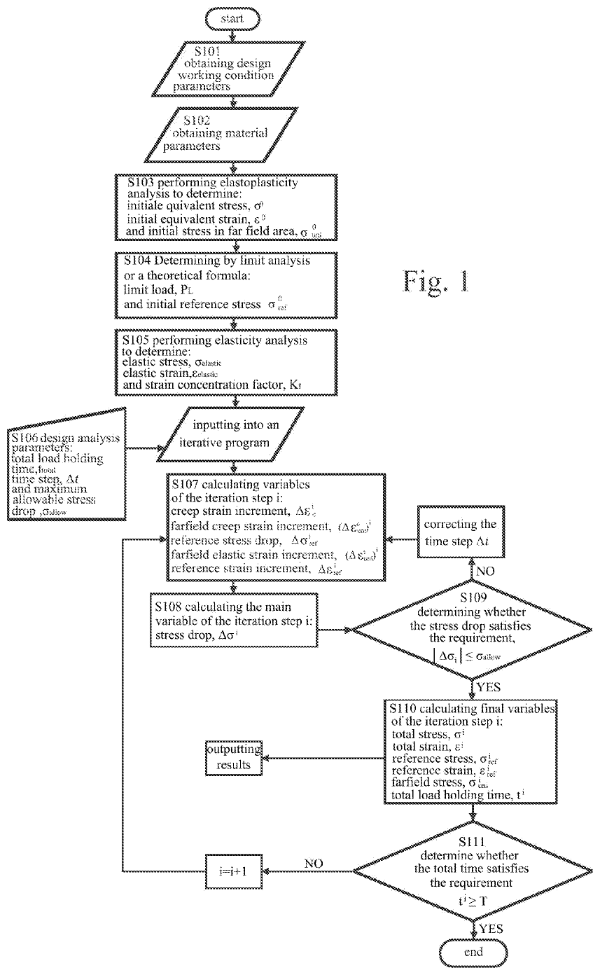

FIG. 1 illustrates a flowchart of a time-dependent local stress-strain method for high-temperature structural strength and service life analysis according to an embodiment of the present application. Referring to FIG. 1, the method of this embodiment comprises the following steps:
S₁₀₁, obtaining design working conditions, wherein the working conditions comprise: a design temperature T, a design load P, design total load holding time tₜₒₜₐₗ, specific material and structural dimensions of a high-temperature structure or component.
S₁₀₂, according to the material and design temperature T in step S₁₀₁, obtaining the material parameters, wherein the material parameters comprise: creep constitutive equation (taking Norton constitutive equation as an example, see the following formula), elastic modulus E, Poisson's ratio v, stress-strain curve, and equivalent elastic modulus Ē;

$${\dot{ε}}_{c} = A {σ}^{n}$$

$$\overline{E} = \frac{3 E}{2 ( 1 + v )} ,$$

$$v = 0.3$$

wherein, \dot{ε}_{c} is the creep strain rate, σ is the stress, A is the creep constitutive parameter, and n is the stress index parameter in the creep constitutive equation. Material parameters can be obtained by querying a material performance library, and material parameters can also be obtained by testing. If the material parameters are obtained by testing, elastic modulus E and Poisson's ratio v can be obtained by performing a static method test or dynamic thermomechanical analyzer test. The creep constitutive equation can be obtained by performing a tensile creep test with round bar. The stress-strain curve can be obtained by performing a tensile test with round bar.
S₁₀₃, performing an elastoplasticity analysis on the high-temperature structure or component based on a finite element method in finite element software, such as Abaqus or Ansys, to determine the initial stress σ⁰ and initial equivalent strain ε⁰ of the critical point under concern in the structural discontinuity area and the initial stress σᵤₙᵢ⁰ the far field area(which can also be determined based on the nominal stress theoretical formula), wherein all the stresses are von-Mises stresses.
S₁₀₄, determining the ultimate load P_{L} of the structure by performing a limit analysis, and calculating the corresponding initial reference stress σ_{ref}⁰ according to the following formula;

$$\text{?} = \frac{P}{{P}_{L}} {σ}_{y} ;$$

$$\text{?} \text{indicates text missing or illegible when filed}$$

wherein, P is the design load, P_{L} is the ultimate load, and σ_{y} is the yield strength, which is the stress corresponding to 0.2% plastic deformation.
S₁₀₅, determining the elastic stress σ_{elastic} and elastic strain ε_{elastic} of critical point under concern in the structural discontinuity area by performing an elastic analysis, and then calculate the corresponding stress concentration factor Kₜ according to the following equation;

$${K}_{t} = \sqrt{\frac{{σ}_{elastic} {ε}_{elastic} E}{{σ}_{ref}^{2}}}$$

wherein, E is the elastic modulus, σ_{ref} is the initial reference stress of the structural critical point.
S₁₀₆, setting the parameters required for analysis: time step Δt, total load holding time tₜₒₜₐₗ, and maximum allowable stress drop per step σ_{allow}. Time step Δt, total load holding time tₜₒₜₐₗ, and maximum allowable stress drop per step σ_{allow} are the boundary conditions for the iterative operation.
S₁₀₇, when the structure is controlled by displacement, calculating the creep strain increment Δε_{c}ⁱ and far field creep strain increment (Δεᵤₙᵢ^{c})ⁱ ) corresponding to the iteration step i according to the creep constitutive equation \dot{ε}_{c}=Aσⁿ, and calculating the reference stress drop Δσ_{ref}ⁱ corresponding to the iteration step i, the far field elastic strain increment (Δεᵤₙᵢ^{c})ⁱ ) corresponding to iteration step i, and the reference strain increment Δε_{ref}ⁱ corresponding to iteration step i according to the following formulas;

$$Δ {σ}_{ref}^{i} = {A ( {σ}_{ref}^{i - 1} )}^{n} Δ tE ,$$

$${( Δ {ε}_{uni}^{ε} )}^{i} = - {A ( {σ}_{ref}^{i - 1} )}^{n} Δ t \cdot \frac{{σ}_{uni}^{0}}{{σ}_{ref}^{0}} ,$$

$$Δ {ε}_{ref}^{i} = {( Δ {ε}_{uni}^{c} )}^{i} + {( Δ {ε}_{uni}^{c} )}^{i} ;$$

when the structure is controlled by load, calculating the far field creep strain increment (Δεᵤₙᵢ^{c})ⁱ=0, far field elastic strain increment (Δεᵤₙᵢ^{c})ⁱ=0, and reference stress drop Δσ_{ref}ⁱ=0 corresponding to the iteration step i, and calculating reference creep increment Δε_{ref}ⁱ according to the following formula;

Δε_{ref}ⁱ=A(σ_{ref}ⁱ⁻)Δt;
S₁₀₈, calculating the stress drop Δσⁱ corresponding to the iteration step i according to the following formula;

$$\text{?} = \frac{\text{?} ( Δ {σ}_{ref}^{i} ( {ε}_{ref}^{i - 1} + Δ {ε}_{ref}^{i} ) + ( Δ {σ}_{ref}^{i} + {σ}_{ref}^{i - 1} ) Δ {ε}_{ref}^{i} ) - \text{?}}{{ε}^{i - 1} + \frac{{σ}^{i - 1}}{\overline{E}} + Δ \text{?}} ;$$

$$\text{?} \text{indicates text missing or illegible when filed}$$

S₁₀₉, judging whether the stress drop Δσⁱ satisfies the requirement of the maximum allowable stress drop σ_{allow} set in S₁₀₆; if satisfies, continuing with S₁₁₀, and if not, adjusting the time step Δt, and repeat S₁₀₇-S₁₀₉ for the iteration step i.
S₁₁₀, updating total stress σⁱ, total strain εⁱ, reference stress σ_{ref}ⁱ, reference strain ε_{ref}ⁱ, far field stress σ_{ref}ⁱ, and total load holding time tⁱ corresponding to the load holding time of the iteration step i, and outputting the above parameters. The corresponding calculation formulas are as follows:

$${σ}^{i} = {σ}^{i - 1} + Δ {σ}^{i} ;$$

$${ε}^{i} = {ε}^{i - 1} + Δ {ε}_{c}^{i} + \text{?} / \overline{E} ;$$

$${σ}_{ref}^{i} = {σ}_{ref}^{i - 1} + Δ {σ}_{ref}^{i} ;$$

$${ε}_{ref}^{i} = {ε}_{ref}^{i - 1} + Δ {ε}_{ref}^{i} ;$$

$${σ}_{uni}^{i} = {σ}_{uni}^{i - 1} - EA ( {σ}_{ref}^{i - 1} \text{?} Δ t \cdot \frac{{σ}_{uni}^{0}}{{σ}_{ref}^{0}} ;$$

$${T}^{i} = {t}^{i - 1} + Δ t ;$$

$$\text{?} \text{indicates text missing or illegible when filed}$$

S₁₁₁, judging whether the load holding time tⁱ of the iteration step i satisfies the requirement for meeting or exceeding the total time tₜₒₜₐₗ; if satisfies, stopping the iterative operation, otherwise proceeding to the iterative operation of step i+1;

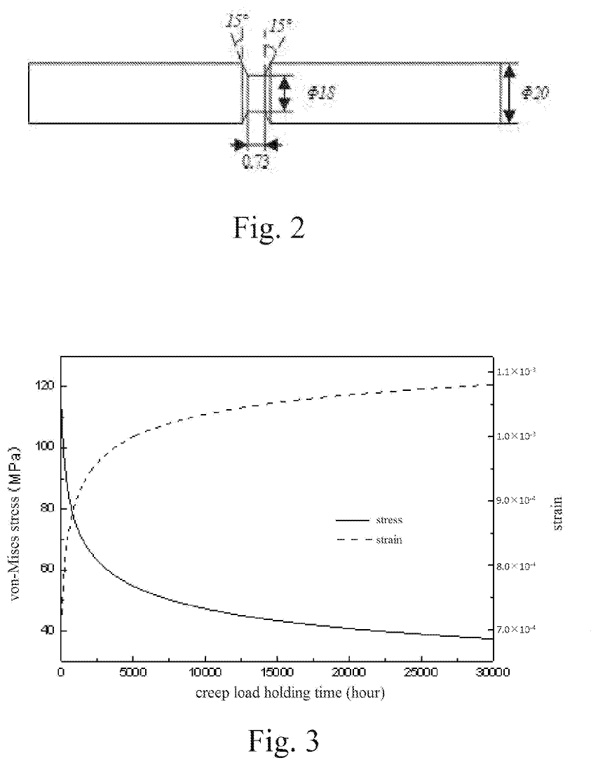

A specific implementation example of the time-dependent local stress-strain method for high-temperature structural strength and service life analysis according to an embodiment of the present application is described below with reference to FIGS. 2 and 3. In this specific implementation example, the load component is a bolt component. It is now necessary to obtain the stress-strain response of the root of its thread under creep conditions for the bolt component. The bolt design temperature is 538° C., the design displacement load is 0.171 mm, the design service life is 30,000 hours, and the material of the component is 316 stainless steel. FIG. 2 illustrates the simplified modeling model of the bolt component, that is, in this example, the load component is a simplified bolt component.

The process flow executed is as follows:
Step 1, obtaining design working conditions. The bolt design temperature T is 538° C., the design displacement load is 0.171 mm, the design life tₜₒₜₐₗ is 30000 hours, and the material of the component is 316 stainless steel. The structural dimensions are shown in FIG. 2: the bolt diameter is 20 mm, the thread diameter is 18 mm, the thread length is 0.73 mm, and the inclination angle of the transition inclined surface between the thread and the bolt is 15 degrees.
Step 2, obtaining material performance data. The static method test was used to obtain an elastic modulus E of 164 GPa and a Poisson's ratio v of 0.3 at 538° C. A tensile test with round bar was performed at 538° C., and the 0.2% plastic elongation strength R_{P0.2} obtained was 136 MPa. A high-temperature tensile creep test with round bar at 538° C. was carried out, and the creep constitutive equation \dot{ε}_{c}=Aεⁿ was obtained from the test.
Step 3, determining the initial stress σ⁰=115.06 MPa and the initial equivalent strain ε⁰=7.01 e−4 at the maximum stress point of the thread root and initial stress in the far field area σᵤₙᵢ⁰=4.27e−4 according to the geometric parameters and material performance data of the bolt component and based on the elastoplasticity finite element analysis.
Step 4, determining the structural limit load P_{L}=109.375 MPa and the initial reference stress σ_{ref}⁰=87.04 MPa according to the geometric parameters and material performance data of the bolt component and based on the limit analysis.
Step 5, setting the parameters required for analysis: Δt=0.1 s, tₜₒₜₐₗ=30000 h, σ_{allow}=0.1 MPa.
Step 6, writing an iterative operation program according to the S₁₀₇-S₁₁₁ mentioned above, inputting the above parameters into the iterative operation program, and carrying out the iterative operation.
Step 7: based on the iterative operation results, obtaining the creep stress-strain behavior at the critical point of the component under the displacement load, as shown in FIG. 3. FIG. 3 illustrates the creep stress-strain behavior at the structural critical point of the simplified bolt component shown in FIG. 2. FIG. 3 is a dual axis chart, wherein the abscissa is the creep load holding time in hours, the left ordinate is the stress and in the illustrated embodiment is the von-Mises stress in MPa, and the right ordinate is the equivalent strain. The solid-line curve in FIG. 3 represents stress, and the dashed-line curve represents strain.

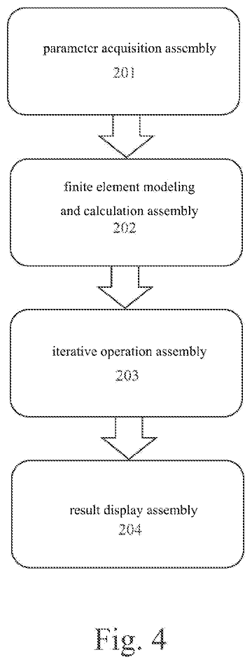

The present application also proposes time-dependent local stress-strain tool software for high-temperature structural strength and service life analysis. FIG. 4 illustrates a structural block diagram of time-dependent local stress-strain tool software for high-temperature structural strength and life analysis according to an embodiment of the present application. The tool software is based on finite element software, which is aimed at a load component under high-temperature conditions, and the load component has a structural discontinuity area. As shown in FIG. 4, the tool software comprises: a parameter acquisition assembly 201, a finite element modeling and calculation assembly 202, an iterative operation assembly 203, and a result display assembly 204.

The parameter acquisition assembly 201 obtains working conditions and material parameters, wherein the working conditions comprise a design temperature, a design load, total load holding time, material of component, and a structural critical point of the component related to the structural discontinuity area, wherein the material parameters comprise the creep constitutive equation, elastic modulus, Poisson's ratio, stress-strain curve, and equivalent elastic modulus of the material. As for the implementation details of the parameter acquisition assembly 201, please refer to the steps S1 and S2 mentioned above.

The finite element modeling and calculation assembly 202 establishes a finite element model based on material parameters; and performs an elastoplasticity analysis based on the finite element model to determine the initial equivalent stress, initial equivalent strain of the structural critical point of the component, and initial stress in the far field area; and performs a limit analysis based on the finite element model to determine the ultimate load and the initial reference stress of the structural critical point; and performs an elasticity analysis based on the finite element model to determine the elastic stress, elastic strain, and stress concentration factor of the structural critical point. In one embodiment, the finite element modeling and calculation assembly 202 is based on engineering simulation finite element software such as Abaqus, Ansys, etc. As for the implementation details of the finite element modeling and calculation assembly 202, please refer to the steps S3, S4, and S5 mentioned above.

The iterative operation assembly 203 sets the boundary conditions for the iterative operation, wherein the boundary conditions comprise: total load holding time, total time, maximum allowable stress drop, and time step. The iterative operation assembly performs an iterative operation step. The iterative operation assembly 203 also performs the iterative operations:

In each iteration step, calculating displacement control intermediate variables and load control intermediate variables, and calculating the resulting variable of each iteration step based on the displacement control intermediate variables and load control intermediate variables, wherein the resulting variable is stress drop;
comparing the stress drop with the maximum allowable stress drop; if the stress drop is greater than the maximum allowable stress drop, adjusting the time step and subsequently recalculates intermediate variables and resulting variable of the iteration step;
if the stress drop is not greater than the maximum allowable stress drop, outputting the calculation results of the iteration step: total stress, total strain, reference stress, reference strain, far field stress, and total load holding time;
judging whether the calculation time has reached the total time; if the total time is reached, ending the iterative operation step;
if the total time is not reached, proceeding to the next iteration step.

The implementation details of the iterative operation assembly 203 can be referred to the steps S6 and S7 mentioned above.

The result display assembly 204 generates a dual axis chart of strain/stress-time according to the calculation results output by all iteration steps, and shows the correlation between local stress and strain of the structural critical point of the component and time. The implementation details of the result display assembly 204 can be referred to the step S8 mentioned above.

In view of the problem of predicting the stress and strain in local areas of the component, the time-dependent local stress-strain method and tool software for high-temperature structural strength and service life analysis proposed in the present application modify the traditional differential Neuber formula based on the stress and strain distribution characteristics of the component, and propose an improved local stress and strain calculation method. In summary, this method and tool software simultaneously solve the problem of predicting stress and strain in local areas of the component under load control or displacement control.

1. A time-dependent local stress-strain method for high-temperature structural strength and service life analysis, wherein said method is aimed at a load component under high-temperature conditions, said load component has a structural discontinuity area, and said method comprises:
a step for obtaining working conditions, wherein said working conditions comprise a design temperature, a design load, total load holding time, material, and a structural critical point of component related to said structural discontinuity area;
a step for obtaining material parameters, wherein said material parameters comprise a creep constitutive equation, an elastic modulus, a Poisson's ratio, a stress-strain curve, and establishing an equivalent elastic modulus of material, and a finite element model according to said material parameters and said working conditions;
an elastoplasticity analysis step, which performs an elastoplasticity analysis based on said finite element model to determine an initial equivalent stress, an initial equivalent strain of said structural critical point of component and an initial stress in a far field area;
a limit analysis step, which performs a limit analysis based on said finite element model to determine an ultimate load and an initial reference stress of said structural critical point;
an elasticity analysis step, which performs an elasticity analysis based on said finite element model to determine an elastic stress, an elastic strain, and a stress concentration factor of said structural critical point;
a boundary condition setting step, which sets boundary conditions for an iterative operation, wherein said boundary conditions comprise: total load holding time, total time, a maximum allowable stress drop, and a time step;
an iterative operation step, which comprises:
in each iteration step, calculating displacement control intermediate variables and load control intermediate variables, and calculating a resulting variable of each iteration step based on displacement control intermediate variables and load control intermediate variables, wherein said resulting variable is a stress drop;
comparing said stress drop with said maximum allowable stress drop; if said stress drop is greater than said maximum allowable stress drop, adjusting said time step and subsequently recalculating intermediate variables and resulting variable of said iteration step;
if said stress drop is not greater than said maximum allowable stress drop, outputting calculation results of said iteration step: a total stress, a total strain, a reference stress, a reference strain, a far field stress, and total load holding time;
judging whether calculation time has reached total time;
if total time has been reached, ending said iterative operation step; and
if total time is not reached, proceeding to a next iteration step; and
a result integration step, which determines a correlation between a local stress and strain of structural critical point of component and time according to calculation results output by all iteration steps.

2. The time-dependent local stress-strain method for high-temperature structural strength and service life analysis according to claim 1, wherein in said step for obtaining material parameters, said material parameters are obtained by querying a material performance library, which comprises:
in said material performance library, obtaining said elastic modulus E, Poisson's ratio v, and creep constitutive equation \dot{ε}_{c}=Aσⁿ of said material at a design temperature T, wherein \dot{ε}_{c} is a creep strain rate, σ is a stress, A is a creep constitutive parameter, and n is a stress index parameter in said creep constitutive equation, and calculating said equivalent elastic modulus Ē:
$$\overline{E} = \frac{3 E}{2 ( 1 + v )} ;$$
obtaining a stress-strain curve of said material at a design temperature T in said material performance library;
or, said material parameters are obtained by testing, which comprises:
testing said material by using a static method or a dynamic thermomechanical analyzer to obtain said elastic modulus E and Poisson's ratio v at a design temperature T,
performing a tensile creep test with round bar on said material at said design temperature T to obtain a creep constitutive equation \dot{ε}_{c}=Aσⁿ, wherein \dot{ε}_{c} is said creep strain rate, σ is said stress, A is said creep constitutive parameter, and n is said stress index parameter in said creep constitutive equation,
calculating said equivalent elastic modulus Ē:
$$\overline{E} = \frac{3 E}{2 ( 1 + v )} ;$$
and
performing a tensile test with round bar on said material at said design temperature T to obtain plastic extension strength of said material, and obtaining a stress-strain curve of said material based on said plastic extension strength.

3. The time-dependent local stress-strain method for high-temperature structural strength and service life analysis according to claim 2, wherein in said limit analysis step, a limit analysis is performed based on a finite element model to obtain said ultimate load P_{L}, and calculating said initial reference stress σ_{ref}⁰ of said structural critical point is calculated according to said ultimate load:
$$\text{?} = \frac{P}{{P}_{L}} {σ}_{y} ;$$
$$\text{?} \text{indicates text missing or illegible when filed}$$
wherein, P is said design load, P_{L} is said ultimate load, and σ_{y} is a yield strength.

4. The time-dependent local stress-strain method for high-temperature structural strength and service life analysis according to claim 3, wherein in said elastic analysis step, said elastic stress σ_{elastic} and elastic strain σ_{elastic} of said structural critical point are determined through elastic analysis based on said finite element model, and then said stress concentration factor Kₜ at said structural critical point is calculated:
$${K}_{t} = \sqrt{\frac{{σ}_{elastic} {ε}_{elastic} E}{{σ}_{ref}^{2}}} ;$$
wherein, E is said elastic modulus, σ_{ref} is said initial reference stress at said structural critical point.

5. The time-dependent local stress-strain method for high-temperature structural strength and service life analysis according to claim 4, wherein
in said iterative operation step, said displacement control intermediate variables comprise: a creep strain increment, a far field creep strain increment, a reference stress drop, a far field elastic strain increment, and a reference strain increment;
when said component is controlled by displacement, as for each iteration step i, said creep strain increment Δε_{c}ⁱ and far field creep strain increment (Δεᵤₙᵢ^{c})ⁱ corresponding to said iteration step i is calculated according to said creep constitutive equation \dot{ε}_{c}=Aσⁿ; and
said reference stress drop Δσ_{ref}ⁱ corresponding to iteration step i is calculated:
Δσ_{ref}ⁱ=A(σ_{ref}ⁱ⁻)ⁿΔtE;
wherein, A is said creep constitutive parameter, E is said elastic modulus, and Δt is said time step;
said far field elastic strain increment (Δεᵤₙᵢ^{ε})ⁱ corresponding to said iteration step i is:
$${( Δ {ε}_{uni}^{ε} )}^{i} = - {A ( {σ}_{ref}^{i - 1} )}^{n} Δ t \cdot \frac{{σ}_{uni}^{0}}{{σ}_{ref}^{0}} ;$$
wherein, Δt is said time step and σᵤₙᵢ⁰ is said initial stress; and
said reference strain increment Δε_{ref}ⁱ corresponding to said iteration step i is:
ε_{ref}ⁱ=(Δεᵤₙᵢ^{c})ⁱ+(Δεᵤₙᵢ^{c})ⁱ.

6. The time-dependent local stress-strain method for high-temperature structural strength and service life analysis according to claim 5, wherein
in said iterative operation step, said load control intermediate variables comprise: said creep strain increment and reference strain increment;
when said component is controlled by a load, as for each iteration step i, said far field creep strain increment is (Δεᵤₙᵢⁱ)ⁱ=0, said far field elastic strain increment is (Δεᵤₙᵢ^{c})ⁱ=0, said reference stress drop is Δσᵤₙᵢⁱ=0, and
said reference creep increment Δε_{ref}ⁱ is calculated as follows:
Δε_{ref}ⁱ=A(σ_{ref}ⁱ⁻)Δt;
wherein, A is said creep constitutive parameter, and Δt is said time step.

7. The time-dependent local stress-strain method for high-temperature structural strength and service life analysis according to claim 6, wherein in said iterative operation step, as for each iterative step i, resulting variable namely said stress drop Δσⁱ is calculated as follows:
$$Δ {σ}^{i} = \frac{\text{?} ( Δ {σ}_{ref}^{i} ( {ε}_{ref}^{i - 1} + Δ {ε}_{ref}^{i} ) + ( Δ {σ}_{ref}^{i} + {σ}_{ref}^{i - 1} ) Δ {ε}_{ref}^{i} ) - {σ}^{i - 1} Δ \text{?}}{{ε}^{i - 1} + \frac{{σ}^{i - 1}}{\overline{E}} + Δ \text{?}} ;$$
$$\text{?} \text{indicates text missing or illegible when filed}$$
wherein, K is said stress concentration factor, εc is a creep strain, ε is an equivalent strain, σ is said stress.

8. The time-dependent local stress-strain method for high-temperature structural strength and service life analysis according to claim 7, wherein in said iterative operation step, as for each iterative step i, if stress drop Δσⁱ is not greater than maximum allowable stress drop σ_{allow}, calculation results of this iteration step are output: a total stress σᵢ, a total strain εᵢ, a reference stress σ_{ref}ⁱ, a reference strain ε_{ref}ⁱ, a far field stress σᵤₙᵢⁱ , and total load holding time tⁱ,
said total stress σⁱ is calculated as follows:
σⁱ=σⁱ⁻+Δσⁱ;
said total strain εⁱ is calculated as follows:
εⁱ=εⁱ⁻+Δε₀ⁱ+Δσⁱ/Ē;
wherein, Ē is said equivalent elastic modulus;
said reference stress σ_{ref}ⁱ is calculated as follows:
σ_{ref}ⁱ=σ_{ref}ⁱ⁻+Δσ_{ref}ⁱ;
said reference strain ε_{ref}ⁱ is calculated as follows:
ε_{ref}ⁱ=ε_{ref}ⁱ⁻+Δε_{ref}ⁱ;
said far field stress σᵤₙᵢⁱ is calculated as follows:
$${σ}_{uni}^{i} = {σ}_{uni}^{i - 1} - {EA ( {σ}_{ref}^{i - 1} )}^{n} Δ t \cdot \frac{{σ}_{uni}^{0}}{{σ}_{ref}^{0}} ;$$
and
said total load holding time tⁱ is calculated as follows:
tⁱ=tⁱ⁻+Δt.

9. The time-dependent local stress-strain method for high-temperature structural strength and service life analysis according to claim 1, wherein said structural critical point is selected from said structural discontinuity area based on a stress field.

10. Time-dependent local stress-strain tool software for high-temperature structural strength and service life analysis, wherein said tool software is based on finite element software, said tool software is aimed at a load component under high-temperature conditions, said load component has a structural discontinuity area, and said tool software comprises:
a parameter acquisition assembly, which obtains working conditions and material parameters, wherein said working conditions comprise a design temperature, a design load, total load holding time, material of component, and a structural critical point of component related to said structural discontinuity area, wherein said material parameters comprise a creep constitutive equation, an elastic modulus, a Poisson's ratio, a stress-strain curve, and an equivalent elastic modulus of said material;
a finite element modeling and calculation assembly, which establishes a finite element model based on said material parameters; performs an elastoplasticity analysis based on said finite element model to determine an initial equivalent stress, an initial equivalent strain of said structural critical point of component, and an initial stress in a far field area; performs a limit analysis based on said finite element model to determine an ultimate load and an initial reference stress of said structural critical point; and performs an elasticity analysis based on said finite element model to determine an elastic stress, an elastic strain, and a stress concentration factor of said structural critical point;
an iterative operation assembly, which sets boundary conditions for said iterative operation, wherein said boundary conditions comprise: total load holding time, total time, a maximum allowable stress drop, and a time step; wherein said iterative operation assembly performs an iterative operation step, which comprises:
in each iteration step, calculating displacement control intermediate variables and load control intermediate variables, and calculating a resulting variable of each iteration step based on said displacement control intermediate variables and load control intermediate variables,
comparing said stress drop with said maximum allowable stress drop; if said stress drop is greater than said maximum allowable stress drop, adjusting said time step and subsequently recalculating intermediate variables and resulting variable of said iteration step;
if said stress drop is not greater than said maximum allowable stress drop, outputting calculation results of said iteration step: a total stress, a total strain, a reference stress, a reference strain, a far field stress, and total load holding time; and
judging whether calculation time has reached total time; if total time has been reached, ending said iterative operation step; if total time has not been reached, proceeding to a next iteration step; and
a result display assembly, which generates a dual axis chart of strain/stress-time according to calculation results output by all iteration steps, and shows a correlation between local stress and strain of said structural critical point of component and time.
